(19) United States
(12) Patent Application Publication
(10) Pub. No.: US 2007/0062318 A1
(43) Pub. Date: Mar. 22, 2007

(54) Transmission device for motorcycle

(76) Inventor: Jui Cheng Chang, Changhua Hsien (TW)

Correspondence Address: CHARLES E. BAXLEY, ESQ., 90 JOHN STREET, THIRD FLOOR, NEW YORK, NY, 10038, US

(21) Appl. No.: 11/201,998

(22) Filed: Aug. 11, 2005

(51) Int. Cl. F16H 3/08

(52) U.S. Cl. 74/325

(57) ABSTRACT

A transmission device includes a spindle and a shaft rotatably supported in a housing, a coupling device for selectively coupling the spindle to the shaft and to rotate the shaft in a same direction as that of the spindle. Another coupling device may selectively couple the spindle to the shaft and to rotate the shaft in a reverse direction as that of the spindle, and includes a driving pinion attached to the spindle, a driven gear is freely and rotatably attached on the shaft and coupled to the driving pinion, and a latching gear movable to selectively engage with the driven gear, to allow the shaft to rotated by the spindle to rotate in a same direction as that of the spindle by the driven gear and the driving pinion.

### BACKGROUND OF THE INVENTION

1. Field of the Invention

The present invention relates to a transmission device, and more particularly to a transmission device for a motorcycle or a beach motor vehicle having a reverse gear shifting or backward motion mechanism for allowing the motorcycle or the beach motor vehicle to selectively move backwardly.

2. Description of the Prior Art

Typical motorcycles or beach motor vehicles comprise a transmission device or mechanism that may be shifted to allow the motorcycles to be powered or driven forwardly in different speeds. However, due to the two-wheeled unsteady structure for the typical motorcycles, the transmission devices or mechanisms for the typical motorcycles do not have reverse gear shifting devices or backward motion mechanisms, such that the typical motorcycles may not be moved backwardly with the typical transmission devices or mechanisms.

For some of the motorcycles or beach motor vehicles, a reverse gear shifting or backward motion mechanism may be required for allowing the motorcycle to selectively move backwardly. However, the typical motorcycles and the typical beach motor vehicles failed to provide a reverse gear shifting or backward motion mechanism for allowing the motorcycles and the typical beach motor vehicles to selectively move backwardly.

The present invention has arisen to mitigate and/or obviate the afore-described disadvantages of the conventional transmission devices.

### SUMMARY OF THE INVENTION

The primary objective of the present invention is to provide a transmission device for a motorcycle including a reverse gear shifting or backward motion mechanism for allowing the motorcycle to selectively move backwardly.

In accordance with one aspect of the invention, there is provided a transmission device comprising a housing, a spindle and a shaft rotatably supported in the housing, a first coupling device for selectively coupling the spindle to the shaft and to rotate the shaft in a same direction as that of the spindle, and a second coupling device for selectively coupling the spindle to the shaft and to rotate the shaft in a reverse direction as that of the spindle.

The second coupling device includes a first driving pinion attached to the spindle and rotated in concert with the spindle, a first driven gear rotatably attached on the shaft and rotatable freely relative to the shaft and coupled to the first driving pinion with a connecting device, and a latching gear slidably attached to the shaft and rotatable by the shaft and movable to selectively engage with the first driven gear, to allow the shaft to rotated by the spindle to rotate in a same direction as that of the spindle by the first driven gear and the first driving pinion and the connecting device.

A pawl may further be provided and engaged with the latching gear, for moving the latching gear to selectively engage with the first driven gear. The housing includes a rod rotatably supported therein, the pawl is slidably attached on the rod with at least one key engagement, and rotated in concert with the rod.

The latching gear includes a peripheral channel formed therein, the pawl includes a recess formed therein and defined by two fingers which are engaged into the peripheral channel of the latching gear, for moving the latching gear along the shaft and to selectively engage with the first driven gear.

The housing further includes a block rotatably supported therein and having a guiding groove formed therein, and the pawl includes an extension extended therefrom and slidably engaged into the guiding groove of the block, to allow the block to move the pawl along the rod.

The first coupling device includes an active pinion attached to the spindle and rotated in concert with the spindle, and a second driven gear freely and rotatably attached onto the shaft, the latching gear is movable to selectively engage with the second driven gear, to allow the shaft to rotated by the spindle to rotate in a reverse direction as that of the spindle by the second driven gear and the active pinion and the latching gear.

The first coupling device includes a first rotating pinion rotatably attached to the spindle and rotatable freely relative to the spindle, and meshed with the latching gear, and the active pinion is movable to selectively engage with the first rotating pinion when the latching gear is disengaged from the first and the second driven gears, to allow the shaft to rotated by the spindle to rotate in a reverse direction as that of the spindle by the active pinion and the first rotating pinion and the latching gear.

A third driven gear is attached to the shaft and rotated in concert with the shaft, a second rotating pinion is rotatably attached to the spindle and rotatable freely relative to the spindle, and meshed with the third driven gear, and the active pinion is movable to selectively engage with the second rotating pinion, to allow the shaft to rotated by the spindle to rotate in a reverse direction as that of the spindle by the active pinion and the second rotating pinion and the third driven gear.

Another pawl may further be provided and engaged with the active pinion, for moving the active pinion to selectively engage with the first rotating pinion. The housing includes a rod rotatably supported therein, the pawl is slidably attached on the rod with at least one key engagement, and rotated in concert with the rod.

The active pinion includes a peripheral channel formed therein, the pawl includes a recess formed therein and defined by two fingers which are engaged into the peripheral channel of the active pinion, for moving the active pinion along the spindle and to selectively engage with the first rotating pinion.

The block further includes another guiding groove formed therein, and the another pawl also includes an extension extended therefrom and slidably engaged into the guiding groove of the block, to allow the block to move the another pawl along the rod.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view of a transmission device for a motorcycle or a beach motor vehicle in accordance with the present invention;

FIG. 2 is a partial exploded view of the transmission device for the motorcycle or the beach motor vehicle;

FIG. 3 is another partial exploded view of the transmission device for the motorcycle or the beach motor vehicle;

FIG. 4 is a partial top plan view of the transmission device for the motorcycle or the beach motor vehicle;

FIG. 5 is a partial cross sectional view of the transmission device, taken along lines 5-5 of FIG. 4; and

FIGS. 6, 7 are partial top plan views similar to FIG. 4, illustrating the operation of the transmission device for the motorcycle or the beach motor vehicle.

### DETAILED DESCRIPTION OF THE PREFERRED EMBODIMENT

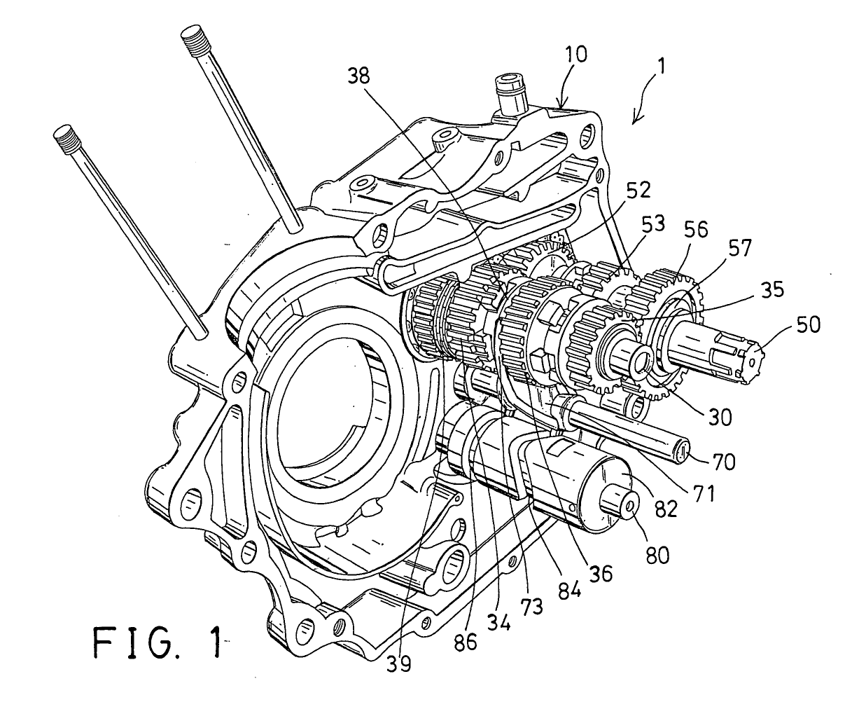

Referring to the drawings, and initially to FIGS. 1-5, a transmission device 1 in accordance with the present invention is provided for attaching to a motorcycle or a beach motor vehicle, and comprises a reverse gear shifting or backward motion mechanism for allowing the motorcycle or the beach motor vehicle to selectively move backwardly.

The transmission device 1 comprises a housing 10 including two orifices 11, 12 formed therein, for rotatably receiving or supporting a spindle 30 and a shaft 50 therein respectively, and one or more apertures 13, 14 formed therein, for rotatably receiving or supporting one or more rods 70, 80 therein respectively, and preferably for allowing the rods 70, 80 to be supported in parallel to the spindle 30 and the shaft 50 respectively.

The spindle 30 is coupled to the engine (not shown) of the motorcycle or the beach motor vehicle, for being rotated or driven by the engine of the motorcycle or the beach motor vehicle, and includes a driving pinion 31 disposed or secured thereon and coupled thereto with one or more key engagements 32 (FIG. 5), for allowing the driving pinion 31 to be rotated or driven by the spindle 30, and to be rotated in concert with the spindle 30.

A gear 33 is solidly secured on the spindle 30 and also arranged to be rotated or driven by the spindle 30, and to be rotated in concert with the spindle 30. Two rotating pinions 34, 35 are rotatably attached or disposed on the spindle 30 and rotatable freely relative to the spindle 30, in which the rotating pinion 34 is preferably disposed beside the driving pinion 31, and rotatably secured to the spindle 30 with such as clamping or retaining rings (not shown), for positioning the driving pinion 31 on the spindle 30, and for preventing the driving pinion 31 from being moved along the spindle 30.

A movable or active pinion 36 is slidably attached or secured to the spindle 30 with one or more key engagements 32 (similar to that shown in FIG. 5), for allowing the active pinion 36 to be rotated or driven by the spindle 30, and to be rotated in concert with the spindle 30. The active pinion 36 and the rotating pinions 34, 35 each includes a coupling device 37 provided thereon, such as a projection-and-recess or key-and-socket coupling device 37, for allowing the active pinion 36 to be selectively engaged with or coupled to either of the rotating pinions 34, 35, for gear shifting or changing purposes.

For example, the active pinion 36 includes a peripheral channel 38 formed therein (FIGS. 1, 2, 4, and 6-7), and a fork or pawl 71 is slidably attached or secured on the rod 70 with one or more key engagements 32 (similar to that shown in FIG. 5), and rotated in concert with the rod 70, and includes a recess 72 formed therein and defined by or between two fingers 73 which may be engaged into the peripheral channel 38 of the active pinion 36, for moving the active pinion 36 along the spindle 30 and to selectively engage with either of the rotating pinions 34, 35.

The shaft 50 includes a sprocket or driven gear 51 rotatably attached or disposed on the shaft 50 and rotatable freely relative to the shaft 50, and coupled to the driving pinion 31 with a connecting device 39, such as a chain 39, a belt, or the like, for allowing the driven gear 41 to be rotated or driven by the spindle 30 via the driving pinion 31 and the connecting device 39. It is to be noted that the driven gear 51 is rotatably attached or disposed on the shaft 50 and rotatable freely relative to the shaft 50, such that the shaft 50 will not be rotated or driven by the spindle 30 via the connecting device 39 and the driven gear 51.

A latching gear 52 is slidably attached or secured to the shaft 50 with one or more key engagements 32 (similar to that shown in FIG. 5), for allowing the latching gear 52 to be rotated or driven by the shaft 50, and to be rotated in concert with the shaft 50, and to be meshed with or engaged with the rotating pinion 34. Two driven gears 53, 56 are also attached onto the shaft 50, in which the driven gear 53 is freely and rotatably attached onto the shaft 50, but the other driven gear 56 is solidly attached or secured to the shaft 50 with one or more key engagements 32 (similar to that shown in FIG. 5), for allowing the driven gear 56 to be rotated or driven by the shaft 50.

It is to be noted that the driven gears 53, 56 are meshed or engaged with the active pinion 36 and the rotating pinion 35 respectively, and the driven gear 53 is freely and rotatably attached onto the shaft 50, in addition, the rotating pinion is also freely and rotatably attached onto the spindle 30, such that the shaft 50 will not be rotated or driven by the spindle 30 via the active pinion 36 and the rotating pinion 35 and the driven gears 53, 56.

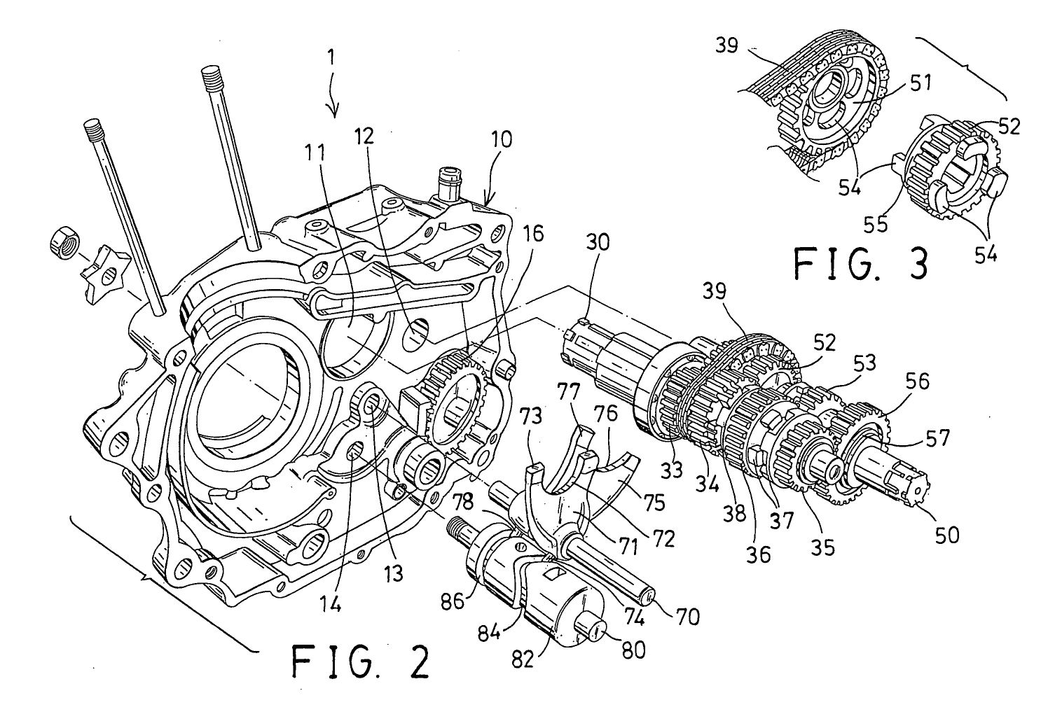

The driven gear 53 and the latching gear 52 and the driven gear 51 each also includes a coupling device 54 provided thereon (FIGS. 3-4 and 6-7), such as a projection-and-recess or key-and-socket coupling device 54, for allowing the latching gear 52 to be selectively engaged with or coupled to either of the driven gears 53, 51, for gear shifting or changing purposes. The other driven gear 56 is further solidly attached or secured to the shaft 50 with one or more clamping or retaining rings 57, for positioning the driven gear 56 on the shaft 50, and for preventing the driven gear 56 from being moved along the shaft 50.

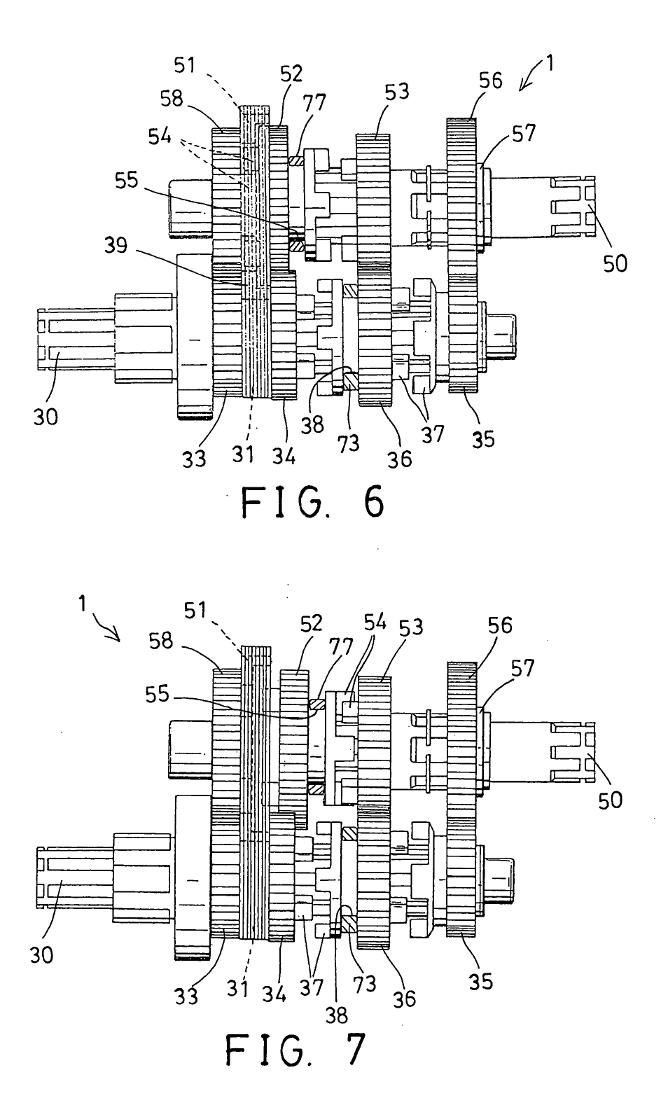

For example, the latching gear 52 also includes a peripheral channel 55 formed therein (FIGS. 3-4, and 6-7), and another fork or pawl 75 is slidably attached or secured on the rod 70 with one or more key engagements 32 (similar to that shown in FIG. 5), and rotated in concert with the rod 70, and includes a recess 76 formed therein and defined by or between two fingers 77 which may be engaged into the peripheral channel 55 of the latching gear 52, for moving the latching gear 52 along the shaft 50 and to selectively engage with either of the driven gears 53, 51 (FIGS. 6, 7).

As shown in FIGS. 1 and 2, the rod 80 includes a block 82 disposed or secured thereon, and having one or more, such as two cam or guiding grooves 84, 86 formed therein, and the pawls 71, 75 each includes an extension 74, 78 extended therefrom, and slidably engaged into the cam or guiding grooves 84, 86 of the block 82 or of the rod 80 respectively, which may move the pawls 71, 75 along the rod 70 respectively, in order to selectively move the active pinion 36 along the spindle 30 and to selectively engage with either of the rotating pinions 34, 35, or to selectively move the latching gear 52 along the shaft 50 and to selectively engage with either of the driven gears 53, 51.

The shaft 50 may further include another driven gear 58 freely and rotatably attached or disposed thereon, and meshed or engaged with the gear 33 of the spindle 30, and also meshed or engaged with such as a starting gear 16 of the housing 10 of the transmission device 1, for allowing the spindle 30 to be rotated or driven by the starting gear 16 via the shaft 50, for example. However, the driving between the spindle 30 and the shaft 50 and the starting gear 16 and the gears 33, 58 is not related to the present invention, and will not be described in further details.

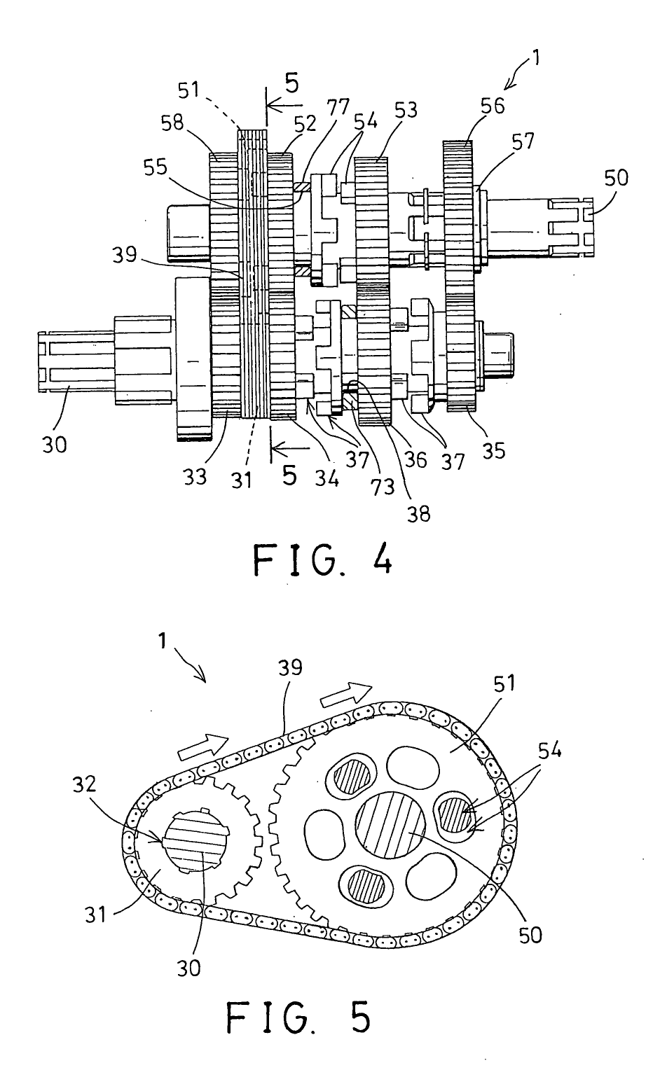

In operation, as shown in FIG. 4, when the active pinion 36 is disengaged from the rotating pinions 34, 35, and when the latching gear 52 is also disengaged from the driven gears 53, 51, the shaft 50 will not be rotated or driven by the spindle 30 via the active pinion 36 and the rotating pinion 35 and the driven gears 53, 56, and also will not be rotated or driven by the spindle 30 via the rotating pinion 34 and the latching gear 52, such that the shaft 50 may not be rotated or driven by the spindle 30 at this moment.

As shown in FIG. 6, when the latching gear 52 is moved by the pawl 75 to engage with the driven gear 51, and because the driven gear 51 and the driving pinion 31 are coupled together with the connecting device 39, such that the shaft 50 may be rotated or driven by the spindle 30 to rotate in the same direction as that of the spindle 30 by the driven gear 51 and the driving pinion 31 and the connecting device 39, best shown in FIG. 5, for allowing the motorcycle or the beach motor vehicle to be driven or moved backwardly by the shaft 50, for example.

As shown in FIG. 7, when the latching gear 52 is disengaged from the driven gear 51, but moved by the pawl 75 to engage with the other driven gear 53, the shaft 50 may be rotated or driven by the spindle 30 to rotate in the opposite or reverse direction as that of the spindle 30 by the latching gear 52 and the driven gear 53 and the active pinion 36, for allowing the motorcycle or the beach motor vehicle to be driven or moved forwardly by the shaft 50 in such as a first gear shift, for example.

When the latching gear 52 is disengaged from both the driven gears 51, 53 by the pawl 75, and when the active pinion 36 is moved to selectively engage with either of the rotating pinions 34, 35, the shaft 50 may also be rotated or driven by the spindle 30 to rotate in the opposite or reverse direction as that of the spindle 30 and to rotate in different speed by the rotating pinion 34 and the latching gear 52 in such as a second gear shift, for example; or by the other rotating pinion 35 and the other driven gear 56 in such as a third gear shift, for example, to allow the shaft 50 to be rotated or driven by the spindle 30 forwardly in different speeds.

Accordingly, the transmission device for the motorcycle or the beach motor vehicle in accordance with the present invention includes a reverse gear shifting or backward motion mechanism for allowing the motorcycle or the beach motor vehicle to selectively move backwardly.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A transmission device comprising:
a housing,
a spindle and a shaft rotatably supported in said housing,
a first coupling means for selectively coupling said spindle to said shaft and to rotate said shaft in a same direction as that of said spindle, and
a second coupling means for selectively coupling said spindle to said shaft and to rotate said shaft in a reverse direction as that of said spindle.

2. The transmission device as claimed in claim 1, wherein said first coupling means includes a driving pinion attached to said spindle and rotated in concert with said spindle, a first driven gear rotatably attached on said shaft and rotatable freely relative to said shaft and coupled to said driving pinion with a connecting device, and a latching gear slidably attached to said shaft and rotatable in concert with said shaft and movable to selectively engage with said first driven gear, to allow said shaft to rotated by said spindle to rotate in a same direction as that of said spindle by said first driven gear and said driving pinion and said connecting device.

3. The transmission device as claimed in claim 2 further comprising a pawl engaged with said latching gear, for moving said latching gear to selectively engage with said first driven gear.

4. The transmission device as claimed in claim 3, wherein said housing includes a rod rotatably supported therein, said pawl is slidably attached on said rod with at least one key engagement, and rotated in concert with said rod.

5. The transmission device as claimed in claim 3, wherein said latching gear includes a peripheral channel formed therein, said pawl includes a recess formed therein and defined by two fingers which are engaged into said peripheral channel of said latching gear, for moving said latching gear along said shaft and to selectively engage with said first driven gear.

6. The transmission device as claimed in claim 5, wherein said housing further includes a rotatable block having a guiding groove formed therein, and said pawl includes an extension extended therefrom and slidably engaged into said guiding groove of said block, to allow said block to move said pawl along said rod.

7. The transmission device as claimed in claim 2, wherein said second coupling means includes an active pinion attached to said spindle and rotated in concert with said spindle, and a second driven gear rotatably attached onto said shaft and meshed with said active pinion, said latching gear is movable to selectively engage with said second driven gear, to allow said shaft to rotated by said spindle to rotate in a reverse direction as that of said spindle by said second driven gear and said active pinion and said latching gear.

8. The transmission device as claimed in claim 7, wherein said second coupling means includes a first rotating pinion rotatably attached to said spindle and rotatable freely relative to said spindle, and meshed with said latching gear, and said active pinion is movable to selectively engage with said first rotating pinion when said latching gear is disengaged from said first and said second driven gears, to allow said shaft to rotated by said spindle to rotate in the reverse direction as that of said spindle by said active pinion and said first rotating pinion and said latching gear.

9. The transmission device as claimed in claim 8, wherein a third driven gear is attached to said shaft and rotated in concert with said shaft, a second rotating pinion is rotatably attached to said spindle and rotatable freely relative to said spindle, and meshed with said third driven gear, and said active pinion is movable to selectively engage with said second rotating pinion, to allow said shaft to rotated by said spindle to rotate in a reverse direction as that of said spindle by said active pinion and said second rotating pinion and said third driven gear.

10. The transmission device as claimed in claim 8 further comprising a pawl engaged with said active pinion, for moving said active pinion to selectively engage with said first rotating pinion.

11. The transmission device as claimed in claim 10, wherein said housing includes a rod rotatably supported therein, said pawl is slidably attached on said rod with at least one key engagement, and rotated in concert with said rod.

12. The transmission device as claimed in claim 10, wherein said active pinion includes a peripheral channel formed therein, said pawl includes a recess formed therein and defined by two fingers which are engaged into said peripheral channel of said active pinion, for moving said active pinion along said spindle and to selectively engage with said first rotating pinion.

13. The transmission device as claimed in claim 12, wherein said housing includes a rotatable block having a guiding groove, and said pawl includes an extension slidably engaged into said guiding groove of said block, for being moved by said block.
